(19) United States
(12) Patent Application Publication
(10) Pub. No.: US 2004/0166904 A1
(43) Pub. Date: Aug. 26, 2004

(54) Power saving method and mechanism for wireless input device

(76) Inventor: Hsiao-Ming Kuo, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/786,521

(22) Filed: Feb. 24, 2004

(30) Foreign Application Priority Data
Feb. 26, 2003 (TW) 092103994

(51) Int. Cl. H04M 1/00; H04B 1/38

(52) U.S. Cl. 455/574

(57) ABSTRACT

A power saving method and a power saving mechanism for use in a wireless input device having a power supply module are proposed. The power saving mechanism has a switch module for allowing the wireless input device to enter a complete power-saving mode or an incomplete power-saving mode. The power saving mechanism further includes a control unit. If the wireless input device is not operated for a certain period of time, the control unit allows the power supply module to temporarily reduce the power supply to the wireless input device until the wireless input device is moved or any button on the wireless input device is actuated. If the wireless input device is in the complete power-saving mode, the power supply is disconnected from the power supply module to the wireless input device.

### FIELD OF THE INVENTION

The present invention relates to power saving methods and mechanisms for input devices, and more particularly, to a power saving method and mechanism for use in a wireless input device for an electronic product.

### BACKGROUND OF THE INVENTION

The wireless mouse is a peripheral input device for a computer, which has the advantage of being operable over a large area without limitation due to a wire length. In most of the commercially available wireless mice, an alkaline battery is used as the electrical power source. This type of electrical power source continuously supplies power even when the wireless mouse is not operated for information input and enters a standby mode. The wireless mouse quickly returns to the normal operation mode as soon as the wireless mouse is touched to move or any button on the wireless mouse is pressed.

Routine replacement of a new battery is necessary in the use of the aforementioned type of wireless mouse. When the cursor cannot be moved on the display screen via the operation of a wireless mouse, it means the battery for the wireless mouse has to be replaced. Further, power consumption constitutes a substantial issue for this type of wireless mouse, especially in the case of a wireless optical mouse. In general, a conventional battery used in a wireless roller mouse allows about 4 months of utilization under normal operating conditions, while in a wireless optical mouse it would allow about 2 months to deplete. Although the power consumption is more economic in the wireless roller mouse, the wireless optical mouse usually is used more than the wireless roller mouse because the latter is often subject to contamination by external particles that adversely affect the sensitivity and performance of the mouse. Furthermore, the response time of the wireless optical mouse is shorter than that of the wireless roller mouse. Therefore, to solve the problem of power consumption of the wireless optical mouse has become a major issue for the mouse manufacturer.

Among many approaches, a wireless optical mouse mounted with a power detection device for controlling the wireless optical mouse to enter various power-saving modes according to the operating status of the wireless optical mouse. To be more specific, the power detection device is managed for automatically selecting an appropriate power-saving mode for the wireless optical mouse in response to the operating status of the wireless optical mouse detected by the power detection device. It thus allows the wireless optical mouse to have relatively low power consumption when not in operation.

However, the wireless optical mouse as described above still consumes power even when not in operation. This is because the wireless optical mouse is designed to be able to resume to operating status as soon as the mouse is moved by a user. Moreover, conventional wireless optical mice aim at solving the power consumption problems occurring in a stationary desktop computer system. When a wireless mouse designed for a desktop computer is used as the peripheral input device of a laptop computer, the wireless mouse may be moved unintentionally and cause unnecessary restart of the normal operation of the wireless mouse. Therefore, power wastage may occur. Due to its portable nature, the laptop computer is often used on an unstable surface, perhaps even the user's laps. As such, the wireless mouse used in the laptop computer may waste a substantial amount of electrical power because it is often inadvertently moved when the user holds the laptop computer. Power wastage from the wireless mice used in the laptop computers, therefore, is a problem for which no satisfactory solutions have been proposed in the art.

### SUMMARY OF THE INVENTION

An object of the present invention is to provide a power saving method and a power saving mechanism for wireless input device such as wireless optical mouse for an electronic product.

Another object of the invention is to provide a power saving method and a power saving mechanism for a wireless input device, which can disconnect the power supply to the wireless input device when the wireless input device is in a complete power-saving mode to prevent a waste of power.

In order to achieve the above and other objectives, the present invention proposes a power saving method for a wireless input device for an electronic product. A power supply module is provided to supply power to electronic components of the wireless input device. The power saving method includes the steps of: 1) providing a switch module to the wireless input device and electrically connecting the switch module to the power supply module; and 2) actuating the switch module by a user to allow the wireless input device to enter a complete power-saving mode or an incomplete power-saving mode; whereby, when the wireless input device is in the complete power-saving mode, the switch module disconnects the supply of power from the power supply module to the wireless input device; and when the wireless input device is in the incomplete power-saving mode, the supply of power from the power supply module to the wireless input device is maintained.

A power saving mechanism proposed in the present invention is used in a wireless input device for an electronic product. The power saving mechanism includes: a power supply module for supplying power to electronic components of the wireless input device for transmitting data wirelessly; a control unit electrically connected to the wireless input device, for controlling and detecting an operating status of the wireless input device, and for determining an amount of power supplied to the wireless input device from the power supply module; and a switch module mounted on a casing of the wireless input device and actuated by a user to allow the wireless input device to enter a complete power-saving mode or an incomplete power-saving mode, and for disconnecting the supply of power from the power supply module to the wireless input device when the wireless input device is in the complete power-saving mode.

### BRIEF DESCRIPTION OF THE DRAWINGS

The present invention can be more fully understood by reading the following detailed description of the preferred embodiments, with reference made to the accompanying drawings, wherein:

FIG. 1 is a block schematic diagram of the internal structure of a power saving mechanism according to the present invention mounted in a wireless optical mouse;

FIG. 2 is a perspective view of the wireless optical mouse with the power saving mechanism having a switch module formed with a protrusion mounted on the bottom of the wireless optical mouse; and

FIG. 3 is a flow chart showing the steps of a power saving method according to the present invention in the use of the power saving mechanism mounted in the wireless optical mouse.

### DETAILED DESCRIPTION OF THE PREFERRED EMBODIMENTS

The present invention provides a power saving method and a power saving mechanism for a wireless input device such as, but not limited to, a wireless optical mouse. It is understood that other input devices having wireless transmission such as wireless keyboard and wireless joystick are suitably used in the present invention.

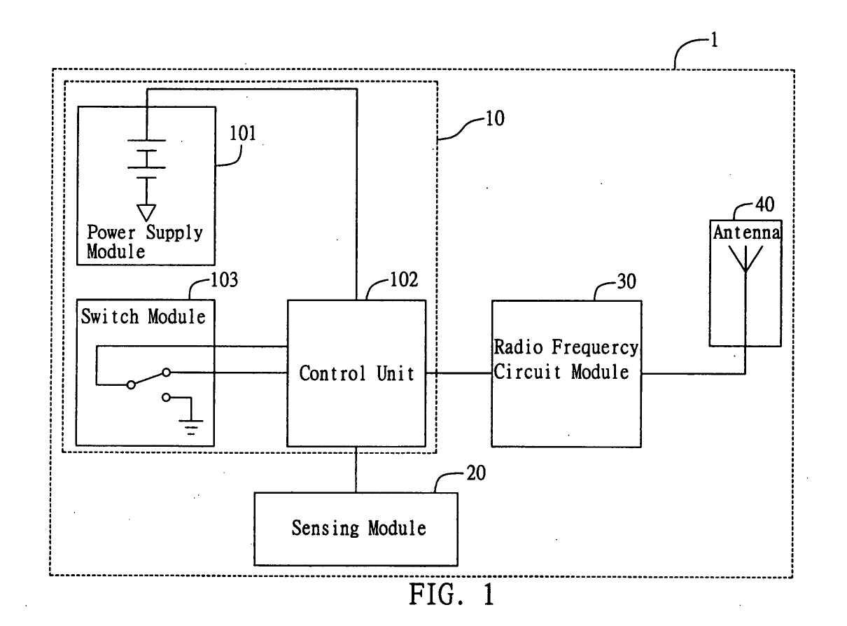

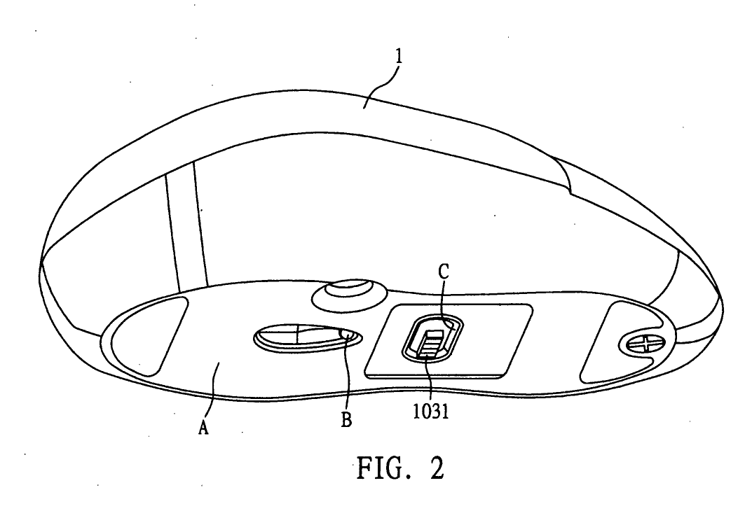

FIG. 1 shows the internal structure of the power saving mechanism according to the present invention mounted in a wireless optical mouse 1. As shown in FIG. 1, the wireless optical mouse 1 includes a power saving mechanism 10, a sensing module 20, a radio frequency circuit module 30, and an antenna 40. The power saving mechanism 10 includes a power supply module 101 such as battery, a control unit 102, and a switch module 103. The switch module 103 is embedded in a recess C at the bottom of a casing A of the wireless optical mouse 1 shown in FIG. 2. The wireless optical mouse 1 can wirelessly transmit data to an electronic product such as laptop computer through a particular wireless channel e.g. radio frequency. The sensing module 20, the radio frequency circuit module 30, and the antenna 40 are conventional equipment for the wireless optical mouse 1, thus not to be further detailed here.

As shown in FIGS. 1 and 2, a light source B is mounted at the bottom of the casing A and sends an optical signal that indicates the position of the mouse 1 to the sensing module 20 where the optical signal is converted to a digital signal. The digital signal is sent to the control unit 102 and processed to calculate where a cursor corresponding to the mouse 1 should be positioned on a display screen of the laptop computer. Then, the control unit 102 transmits the calculated result to the radio frequency circuit module 30. The radio frequency circuit module 30 wirelessly transmit the signal data indicating the position of the mouse 1 to a receiver (not shown) on the laptop computer via the antenna 40 serving as a transmission terminal. Thereby, a user can see the corresponding position of the cursor on the display screen to operate the mouse 1. The light source B of the mouse 1 is always on to allow the power supply module 101 to provide proper power supply to the mouse 1 according to the operating status of the mouse 1. When the mouse 1 is in an incomplete power-saving mode such as standby mode, it can be immediately actuated to enter an operation mode upon receiving a proper command. The sensing module 20 automatically detects the operating status of the mouse 1 and sends a digital signal reflecting the detected operating status to the control unit 102. The control unit 102 processes the digital signal to determine and obtain the operational status of the mouse 1. If the frequency of operating the mouse 1 or the moving range of the mouse 1 is increased, it implies that the user is using the mouse 1. As a result, the control unit 102 allows the power supply module 101 to provide the mouse 1 with sufficient power for normal operation. On the contrary, if the mouse 1 stays in a position for a certain period of time or no button on the mouse 1 is actuated or pressed, the control unit 102 determines that the mouse 1 is in the standby mode, thereby making the power supply module 101 reduce the power supplied to the mouse 1. Once the user moves the mouse 1 or presses any button on the mouse 1, the mouse 1 can be quickly actuated to enter the operation mode and supplied with power for normal operation. Therefore, when the mouse 1 is in the incomplete power-saving mode, it consumes the power from the power supply module 101.

On the other hand, in the use of the power saving mechanism 10, the wireless optical mouse 1 is allowed to enter a complete power-saving mode when it is not operated for a long time or when the user carries the mouse 1 along with the laptop computer, such that the mouse 1 does not consume any power from the power supply module 101. This is achieved, as shown in FIG. 2, by actuating the switch module 103 that is formed with a switch e.g. protrusion 1031, such that the user can manually operate the switch 1031 to allow the mouse 1 to enter the complete power-saving mode or the incomplete power-saving mode. When the mouse 1 is in the complete power-saving mode, the switch module 103 disconnects the supply of power from the power supply module 101 to the mouse 1, such that the mouse 1 would not be supplied with power during the movement of the laptop computer, and, the power from the power supply module 101 would not be wasted.

As shown in FIG. 2, the switch 1031 of the switch module 103 is also embedded in the recess C at the bottom of the casing A in contact with a plane where the wireless optical mouse 1 is placed. This embedded arrangement allows smooth movement of the wireless optical mouse 1 on the plane, and prevents any operational interruption of the mouse 1 if the switch 1031 is not embedded and accidentally actuated making the mouse 1 power off.

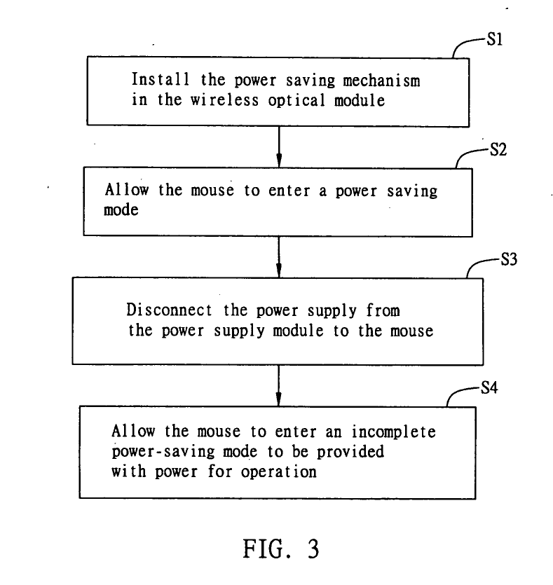

FIG. 3 shows the steps of a power saving method according to the present invention in the use of the power saving mechanism 10 with reference to FIGS. 1 and 2. First in step S1, the power saving mechanism 10 is mounted in the wireless optical mouse 1. The power saving mechanism 10 includes a power supply module 101, a control unit 102, and a switch module 103, to provide a power saving function to the wireless optical mouse 1. Then, it proceeds to step S2.

In step S2, the switch module 103 is actuated by the user to allow the wireless optical mouse 1 to enter a complete power-saving mode. The switch module 103 is formed with a switch such as protrusion 1031 embedded in the recess C at the bottom of the casing A of the mouse 1. The bottom of the casing A is in contact with a plane on which the mouse 1 is placed. The switch 1031 is manually operated by the user to set the mouse 1 in the complete power-saving mode. Then, it proceeds to step S3.

In step S3, when the operation mode of the mouse 1 is in the complete power-saving mode, the switch module 103 disconnects the power supplied from the power supply module 101 to the mouse 1. In this case, even the mouse 1 is moved, no power would be provided from the power supply module 101 to the mouse 1. Then, it proceeds to step S4.

In step S4, when the user intends to operate the mouse 1, the switch 1031 of the switch module 103 can be actuated to set the mouse 1 in an incomplete power-saving mode, so as to resume the power supplied from the power supply module 101 to the mouse 1 for operation.

Therefore, the power saving mechanism and method for the wireless input device according to the invention effectively prevent any power from consumed by the wireless input device due to unintentional movement of the wireless input device for example being carried by the user when the wireless input device is in the incomplete power-saving mode. Thereby, the lifetime of the power supply module and the wireless input device can both be prolonged.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A power saving method for a wireless input device for an electronic product, a power supply module being provided to supply power to electronic components of the wireless input device, the method comprising the steps of:
1) providing a switch module to the wireless input device and electrically connecting the switch module to the power supply module; and
2) actuating the switch module by a user to allow the wireless input device to enter a complete power-saving mode or an incomplete power-saving mode;
whereby, when the wireless input device is in the complete power-saving mode, the switch module disconnects the supply of power from the power supply module to the wireless input device; and when the wireless input device is in the incomplete power-saving mode, the supply of power from the power supply module to the wireless input device is maintained.

2. The method of claim 1, wherein the wireless input device is a wireless optical mouse.

3. The method of claim 2, wherein when the wireless optical mouse is in the incomplete power-saving mode, it is set in a standby mode with reduced supplied power and actuated to enter an operation mode by moving the mouse or pressing a button on the mouse.

4. The method of claim 1, wherein the wireless input device is allowed to transmit data wirelessly.

5. The method of claim 1, wherein the power supply module is a battery.

6. The method of claim 1, wherein the switch module is formed with a switch that is operated manually to set the wireless input device in the complete or incomplete power-saving mode.

7. The method of claim 1, wherein the switch module is embedded in the bottom of a casing of the wireless input device.

8. The method of claim 7, wherein the bottom of the casing is in contact with a plane on which the wireless input device is placed.

9. The method of claim 1, wherein the electronic product is a laptop computer.

10. The method of claim 1, wherein the complete power-saving mode is a status with no supply of power from the power supply module to the wireless input device.

11. A power saving mechanism for a wireless input device for an electronic product, comprising:
a power supply module for supplying power to electronic components of the wireless input device for transmitting data wirelessly;
a control unit electrically connected to the wireless input device, for controlling and detecting an operating status of the wireless input device, and for determining an amount of power supplied to the wireless input device from the power supply module; and
a switch module mounted on a casing of the wireless input device and actuated by a user to allow the wireless input device to enter a complete power-saving mode or an incomplete power-saving mode, and for disconnecting the supply of power from the power supply module to the wireless input device when the wireless input device is in the complete power-saving mode.

12. The power saving mechanism of claim 11, wherein the wireless input device is a wireless optical mouse.

13. The power saving mechanism of claim 11, wherein the wireless input device is allowed to transmit data wirelessly.

14. The power saving mechanism of claim 11, wherein the power supply module is a battery.

15. The power saving mechanism of claim 11, wherein the switch module is formed with a switch that is operated manually to set the wireless input device in the complete or incomplete power-saving mode.

16. The power saving mechanism of claim 11, wherein the switch module is embedded in the bottom of the casing of the wireless input device.

17. The power saving mechanism of claim 16, wherein the bottom of the casing is in contact with a plane on which the wireless input device is placed.

18. The power saving mechanism of claim 11, wherein the complete power-saving mode is a status with no supply of power from the power supply module to the wireless input device.
